(19) United States
(12) Patent Application Publication
(10) Pub. No.: US 2012/0015070 A1
(43) Pub. Date: Jan. 19, 2012

(54) FERMENTED MILK BEVERAGE

(75) Inventors: Bill Vanderkooi, (US); Melinda Ouwerkerk, (US)

(73) Assignee: Nutritech Solutions Ltd., Abbotsford (CA)

(21) Appl. No.: 12/987,006

(22) Filed: Jan. 7, 2011

(30) Foreign Application Priority Data
Jul. 14, 2010 (CA) 2,707,721

(51) Int. Cl. A23C 9/152; A23C 9/123; A23C 9/158

(52) U.S. Cl. 426/2; 426/580; 426/583; 426/73; 426/61; 426/42; 426/43

(57) ABSTRACT

A beverage comprising a fermented milk product and an egg product, and methods for making such a beverage are described.

This application claims priority under 35 U.S.C. §119(e) from U.S. provisional patent application No. 61/040,558, which was filed on Mar. 28, 2008, and which is incorporated herein in its entirety.

### TECHNICAL FIELD

The present invention relates to fermented milk beverages, and methods of making same.

### BACKGROUND

Athletic training, participation in various sporting events and workouts may put an increased metabolic load on the body, and the resulting nutritional needs are often neglected. Water consumption is essential, but does not replace carbohydrates, electrolytes or vitamins, or provide protein and other nutritional factors necessary to rebuild tissue. This may lead to fatigue and muscle soreness, and may have a detrimental effect on future athletic performance.

It is now known that merely rehydration—while beneficial and necessary—may be insufficient for high-performance athletes when managing their multifaceted needs. The complex nutritional requirements, sometimes significant caloric consumption and careful monitoring of fat intake, along with providing nutrients to facilitate tissue repair and muscle recovery following a workout makes selection and consumption of a suitable product (usually a beverage) an important consideration.

A variety of beverages are suggested as being suitable for consumption following athletic training or similar strenuous activities. These beverages, alternately referred to as ‘supplements’, ‘athletic recovery beverages’ or the like, range from plain water (for rehydration), to those comprising balanced electrolytes with simple carbohydrates, to more complex products with mixtures of proteins tailored for fast recovery, building muscle mass, repairing muscle damage or the like. Even the childhood favourite—chocolate milk—is now considered a suitable ‘athletic recovery beverage’.

This suitability of chocolate milk, or milk generally, is not misplaced—milk rehydrates, and provides carbohydrates and electrolytes, and further provides a high concentration of digestible protein. Milk provides both slow absorbed protein (casein) and fast-absorbed protein (whey), in approximately a 3:1 ratio, which may benefit a subject consuming a milk-based product in multiple ways. Slowly absorbed casein promotes protein deposition by inhibiting protein breakdown, while the fast-absorbing whey may stimulate protein synthesis. Whey protein is also a source of branched chain amino acids, which may have an anabolic effect on protein metabolism. The calcium content of milk may be of further benefit, by stimulating the burning of body fat for energy, and decreasing fat storage.

Fresh, skim milk is an excellent source for all of these benefits, but being a fresh product, has a limited storage life, and may further be inconvenient to carry during a workout (e.g. a long hike, or exercising while away from refrigeration facilities). Warm milk, while also subject to spoilage, is generally unpalatable, even with adding flavour and sugar, such as found in chocolate milk. Dried milk may provide the majority of the benefits, but still requires reconstitution, thus taking away the convenience of a ready-to-consume beverage.

It has further been found that fatty acids, in particular omega-3 fatty acids, are important, although frequently deficient in the average North American diet. Omega-3 fatty acids have anti-inflammatory functionality. They may also play an important role in cardiovascular health and pulmonary health. Omega-3 fatty acids may enhance blood flow and oxygen delivery to cells and/or tissues.

A significant dietary source of omega-3 fatty acids, particularly long chain fatty acids such as docosahexaenoic acid (DHA), eicosapentaenoic acid (EPA), moroctic acid, eicosatetraenoic acid, heneicosapentaenoic acid, docosapentaenoic acid and alpha-linolenic acid (ALA) is fatty fish and fish oils. The flavour of fatty fish and fish oils however may be strong and may generally be considered to be an unsuitable taste combination with milk.

Accordingly, there is a need for a beverage that provides the nutritional benefits of fresh milk, with the added benefits of particular fatty acid combinations, vitamins and other nutrients, in a convenient form.

### SUMMARY OF THE INVENTION

The present invention relates to a fermented milk beverage comprising an egg product, and methods of making same.

According to the present invention there is provided a fermented milk beverage comprising an egg product. In one aspect, fluid milk may be combined with an egg product, and one or more microbial strains capable of fermenting lactose to lactic acid. This combination may be incubated at a suitable time and temperature to facilitate fermentation, and the fermentation stopped when a suitable pH is reached.

In one aspect, fluid milk may include fresh milk, reconstituted dried milk, pasteurized or ultra-high temperature treated milk, or a combination thereof.

In one aspect, a suitable pH is about 4.2 to about 4.6, or any amount therebetween. In another aspect, a suitable temperature is about 35° C. to about 45° C., or any amount therebetween.

In another aspect, a suitable time is from about 0.5 hours to about 8.0 hours, or any amount therebetween.

Another aspect of the present invention relates to a beverage comprising a fermented milk product and an egg product.

In one aspect, the fermented milk product may comprise yogurt, and the egg product may be a whole egg, egg yolk, egg white, reconstituted dried whole egg, egg yolk or egg white, or a combination thereof. In another aspect, the fermented milk product may comprise from about 20% to about 80% w/w of the beverage.

In another aspect, the beverage may further comprise one or more of omega-3 fatty acids, phosphatidylcholine, vitamin D, or a combination thereof.

In another aspect, the egg product may be an enhanced egg product. The enhanced egg product may comprise one or more of omega-3 fatty acids, vitamin D, or phosphatidylcholine.

In another aspect, the vitamin D may be vitamin D2, vitamin D3, or a combination of vitamin D2 and vitamin D3.

In another aspect, the omega-3 fatty acids may include one or more of docosahexaenoic acid (DHA), eicosapentaenoic acid (EPA), or alpha-linolenic acid (ALA). The omega-3 fatty acids may be present in an amount of at least 50 milligrams of DHA, and/or at least 5 milligrams of EPA, and/or at least 50 milligrams of ALA.

In another aspect, the beverage may further comprise one or more probiotic microbial strains. The probiotic microbial strains may include one or more of Lactobacillus helveticus, Lactobacillus acidophilus, Lactobacillus rhamnosus GG, Streptococcus thermophilus and Lactobacillus bulgaricus.

In another aspect, the beverage may further comprise one or more of the following: a stabilizer, a colour, a vitamin mixture, a flavour additive, or a combination thereof.

In another aspect of the invention, the yogurt, may have a pH in the range of about 4.3 to about 4.6.

According to another aspect, the present invention relates to a method of making a beverage comprising a fermented milk product and an egg product, the method comprising combining a culture base with a stabilizer, wherein the culture base comprises from 40 to 80% w/w of the beverage.

In another aspect, the culture base may be prepared by homogenizing fluid milk, adding a yogurt mother; and incubating at a suitable temperature until a pH of between about 4.2 to about 4.6 is reached.

In another aspect, the fluid milk may include fresh milk, reconstituted dried milk, pasteurized or ultra-high temperature treated milk, or a combination thereof.

In another aspect, the yogurt mother includes one or more of Streptococcus thermophilus and Lactobacillus bulgaricus.

In another aspect, the stabilizer blend comprises one or more of maltodextrin, a sweetener, milk powder, a thickener, an egg product, a flavour or a colour.

In another aspect, the egg product is an enhanced egg product. The egg product may be a fresh whole egg, fresh egg yolk, fresh egg white, reconstituted dried whole egg, egg yolk or egg white, or a combination thereof. In some aspects, the egg product may further comprise one or more omega-3 fatty acids, vitamin D, phosphatidylcholine or a combination thereof.

In another aspect, the omega-3 fatty acids may be docosahexaenoic acid (DHA), eicosapentaenoic acid (EPA) or alpha-linolenic acid (ALA), or a combination thereof.

In another aspect, the method further comprises a step of adding one or more probiotic microbial strains. The probiotic microbial strains may include one or more of Lactobacillus helveticus, Lactobacillus acidophilus, Lactobacillus rhamnosus GG, Streptococcus thermophilus and Lactobacillus bulgaricus.

The present invention also relates to a method of providing nutrition to a subject, comprising administering to the subject the beverage of the present invention.

A combination of egg and dairy ingredients (e.g. milk, milk products or fermented milk products) may provide carbohydrates, protein, electrolytes, vitamins and minerals, omega-3 fatty acids and phosphatidylcholine in the form of a beverage. A favourable taste and consistency may be obtained by use of a cultured dairy base comprising yogurt, combined with a stabilizer blend. The stabilizer blend may comprise one or more of sugar, egg yolk. pectin and water, and may further comprise flavour and/or coloring agents. In some aspects, an egg product (e.g. an enhanced egg yolk) may provide one or more of omega-3 fatty acids, vitamin D, phosphatidylcholine, vitamins and minerals.

This summary of the invention does not necessarily describe all features of the invention. Other aspects, features and advantages of the present invention will become apparent to those of ordinary skill in the art upon review of the following description of specific embodiments of the invention.

### DETAILED DESCRIPTION

Use of examples in the specification, including examples of terms, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning.

The present invention relates to a beverage comprising a fermented milk product and an egg product. In some exemplary embodiments, the beverage may further comprise one or more of omega-3 fatty acids docosahexaenoic acid (DHA), eicosapentaenoic acid (EPA) and alpha-linolenic acid (ALA), vitamin D, phosphatidylcholine, one or more probiotic microbial strains, stabilizers, texturizing agents, colours, vitamin mixtures, flavour additives or sweeteners.

Milk provides fast-digesting (whey) and slow-digesting (casein) proteins, as well as carbohydrates, electrolytes (e.g. Na, K) and water. As addressed above, fresh or reconstituted milk may be subject to spoiling if not stored correctly (e.g. refrigerated).

The fermented milk product may comprise yogurt (alternate spellings include yogourt, yoghurt or the like). Milk used in a fermented milk product may be whole, partly skim, or skim, homogenized or unhomogenized, or may be a reconstituted dried milk of any of the above types of milk. The milk may be animal milk, for example, bovine (cow), caprine (goat), equine (horse) or ovine (sheep). To produce a fermented milk product, the milk may be pasteurized, cooled to a suitable temperature and combined with a culture or ‘yogurt mother’ or ‘mother culture’. The yogurt mother may be a previously prepared fermented milk product, or may comprise the bacteria that perform the fermentation dispersed in a suitable media. Microbial strains that may be used in preparation of a fermented milk product include one or more of Streptococcus thermophilus or Lactobacillus bulgaricus.

Yogurt may provide, at least in part, the protein complement of milk, with an added advantage over milk in that much of the lactose may be converted to lactic acid during the fermentation process. Thus, yogurt may be tolerated by those who demonstrate some degree of lactose intolerance. Further if not pasteurized after fermentation, yogurt may provide beneficial bacteria (probiotic bacteria). Yogurt further provides an advantage over fresh or reconstituted milk when used in a beverage according to some exemplary embodiments herein, in that the acidic pH may provide a refreshing mouthfeel, and/or may impart a preservative effect on the beverage. While fresh milk has a pH of about 6.5 to about 6.7, the lactic acid produced during fermentation lowers the pH to a range of about 4.2 to about 4.6. In some exemplary embodiments of the present invention, the fermented milk product may have a pH of 4.2, 4.3. 4.4, 4.5 or 4.6, or any pH therebetween. The acidic pH may also be beneficial in preventing colonization and/or undesired microbial growth.

An egg product may include a fresh, whole egg (e.g. both white and yolk together combined), an egg yolk from a fresh egg, egg white from a fresh egg, or a combination thereof. The whole egg may be processed so as to blend the egg white component with the egg yolk component, to provide a substantially homogeneous egg product. Alternately, the egg yolk or egg white may be separated from the whole egg, and used independently. In some exemplary embodiments, the egg product may be an enhanced egg, or an egg yolk or egg white from an enhanced egg. An egg, egg yolk, or egg white may also provide essential amino acids, several vitamins (including vitamin D), several minerals and phosphatidylcholine. When an enhanced egg is used, additional Vitamin D and/or one or more omega-3 fatty acids may be provided. The egg product may be pasteurized according to conventional methods before use as a component of a beverage according to some exemplary embodiments herein.

An enhanced egg is an egg that has been fortified with additional nutrient factors beyond the level that would be found in a non-enhanced egg, or that would not otherwise be found in a non-enhanced egg. Examples of such nutrient factors include, but are not limited to, omega-3 fatty acids docosahexaenoic acid (DHA), eicosapentaenoic acid (EPA), moroctic acid, eicosatetraenoic acid, heneicosapentaenoic acid, docosapentaenoic acid and alpha-linolenic acid (ALA); particularly DHA, EPA and/or ALA, vitamin D, vitamin E and selenium. Methods of producing enhanced eggs are described, for example, in U.S. Pat. Nos. 5,897,890, 4,918,104, and in Mattila et al., 2004. Poultry Science 83:433-440. An example of an enhanced egg that may be used in the beverage of the present invention is VitalaEggs™.

An enhanced egg, or a yolk or egg white from an enhanced egg, may comprise from 50 mg to 500 mg, or more omega-3 fatty acids, in various combinations. This may include from about 20 to about 300 mg of DHA, or any amount therebetween; for example, 50, 100, 150, 200 or 250 mg DHA, or any amount therebetween. This may further, or alternately, include from about 5 to about 200 mg of EPA, or any amount therebetween; for example, 50, 100 or 150 mg EPA, or any amount therebetween. This may further, or alternately, include from about 20 to about 600 mg of ALA, or any amount therebetween; for example, 50, 100, 150, 200, 250, 300, 350, 400, 450, 500 or 550 mg ALA, or any amount therebetween. In some exemplary embodiments, the beverage includes a yolk of an enhanced egg, comprising at least 50, 100, 150 or 200 mg of DHA, per yolk. In an exemplary embodiment, an enhanced egg yolk comprises about 100 mg of DHA, 200 mg of ALA, and about 5 to about 50 milligrams of EPA.

Vitamin D is a necessary nutrient for growth and development of bones and teeth, through proper utilization of dietary phosphorous and calcium. Vitamin D refers generally to a family of five secosteroids—D1 (molecular compound of ergocalciferol with lumisterol), D2 (ergocalciferol), D3 (cholecalciferol), D4 (22-dihydroergocalciferol) and D5 (sitocalciferol). The two major forms are D2 and D3, which may be referred to collectively as calciferol. D2 is not produced by vertebrates and must be provided in the diet, while D3 is produced by the skin when 7-dehydrocholesterol reacts with UV light.

In some exemplary embodiments, an egg, egg white or egg yolk, for example an enhanced egg, or egg white or yolk from an enhanced egg, may comprise from about 0.25 microgram to about 10 micrograms Vitamin D (about 10 IU to about 400 IU of Vitamin D), or any amount therebetween. One IU of Vitamin D is defined in the art as the biological equivalent of 0.025 μg of cholecalciferol or ergocalciferol. In some embodiments, the egg, or enhanced egg, may comprise about 0.5, 1, 2, 3, 4, 5, 6, 7, 8, or 9 micrograms of vitamin D, or any amount therebetween; the vitamin D provided as vitamin D2 or vitamin D3, or a combination of vitamin D2 and vitamin D3, or any amount therebetween.

Inclusion of vitamin D in a beverage according to some exemplary embodiments of the invention may provide a nutritional benefit to the subject consuming the beverage, and may benefit athletic performance. Vitamin D has been associated with an increase in number and/or size of fast twitch muscle fibers, improvement of balance and/or reaction times. Vitamin D may also have a role in reducing stress fractures and muscle ache or discomfort following exercise.

Inclusion of choline in a beverage according to some exemplary embodiments of the invention may also provide a nutritional benefit to the subject consuming the beverage, and may benefit athletic performance. Choline is an essential nutrient required for brain and memory development, cardiovascular health, proper liver function and/or nutrient transport. Dietary supplementation of phosphatidylcholine has been associated with preventing depletion of circulatory choline following exercise, and may improve performance, and/or reduce fatigue and/or improve recovery following exercise. An egg yolk provides about 600 mg of total choline per 100 g, primarily as phosphatidylcholine (630 mg phosphatidylcholine per 100 g of egg yolk. Choline may provided in a beverage according to some exemplary embodiments by inclusion of egg yolk, as a separate component, independent of the egg yolk component, or a combination thereof. An exemplary quantity of choline (from egg yolk, as separate component or combination thereof) to be included in such a beverage is from about 100 to about 200 mg (per serving), or any amount therebetween, for example 120, 140, 160 or 180 mg (per serving) or any mount therebetween. It has been recommended that a suitable daily intake of choline is about 425 milligrams/per day for women aged 19 and older, and 550 milligrams/per day for men aged 19 and older (Institute of Medicine, Food and Nutrition Board).

Omega-3 fatty acids may be included in a beverage according to some exemplary embodiments as a component of an enhanced egg product (as described above); alternately, or additionally, omega-3 fatty acids may be included as a separate ingredient, such as from fish or algal oil, or from egg oil obtained from an enhanced egg. Recommended daily consumption of omega-3 fatty acids, such as long chain omega-3 fatty acids (for example, EPA and/or DHA) may range from about 250 mg to about 4 g per day, however this may vary, depending on the recommending authority. Sources of fish oil may include oils extracted from tuna, menhaden, herring, salmon or the like. Alternately, omega-3 fatty acids may be obtained from commercial available sources for example, OMEGAPURE™, (Omega Protein, Inc.) or MEG-3™ (Ocean Nutrition Canada).

It may be beneficial for a subject with elevated blood, serum or plasma triglyceride levels to consume omega-3 fatty acids regularly, even daily. Methods of determining triglyceride levels in blood, plasma or serum are well-known in the art, and identification of a subject with elevated triglycerides is within the ability of a person skilled in the art. Beverages comprising omega-3 fatty acids, such as those exemplified herein, may be provided to a subject with elevated blood, plasma or serum triglycerides.

Inclusion of omega-3 fatty acids in a beverage, as part of the yolk of an enhanced egg may provide a benefit to the formulation and stability of the beverage, in that the phosphatidylcholine of the egg yolk may aid in emulsifying the fish, algal or egg oil component and prevent separation from the aqueous phase, thus maintaining a substantially homogeneous beverage. Alternately, the fish, egg or algal oil may be combined with the yolk of a non-enhanced egg and the resulting emulsion included in the beverage.

Inclusion of omega-3 fatty acids in a beverage according to some exemplary embodiments of the invention may provide a nutritional benefit to the subject consuming the beverage, and may benefit athletic performance. The benefits of consumption of omega-3 fatty acids may include one or more of: improved blood flow, improved oxygen delivery to muscles, decreased risk for coronary heart disease (CHD), or the like. Omega-3 fatty acid consumption may also be beneficial for a subject with exercise-induced asthma. Dietary intake of omega-3 fatty acids may improve body composition and reduce body fat. Dietary intake of omega-3 fatty acids may lower blood, serum or plasma triglycerides in a subject with normal, or elevated blood, serum or plasma triglycerides.

Inclusion of egg yolk from an enhanced egg (comprising 50 mg to 750 mg, or more omega-3 fatty acids as described above) may provide a further benefit in that the generally unappealing ‘fishy’ odor or taste of a fish or algal oil is masked when the fatty acids comprise a portion of the lipid component of the egg yolk (compared to an egg yolk/fish or algal oil emulsion included in the beverage).

In some exemplary embodiments, the beverage may further comprise one or more probiotic microbial strains. Probiotic microbial strains may include bacteria or yeast; examples of probiotic microbial strains include, without limitation, Lactobacillus helveticus, Lactobacillus acidophilus spp, Lactobacillus casei sp, Lactobacillus rhamnosus GG, Streptococcus thermophilus, Lactobacillus bulgaricus, Lactobacillus reuteri, Lactobacillus delbrueckii bulgaricus, Lactobacillus planatarum spp., Lactobacillus fermentum KLD, Lactobacillus johnsonii, Bifidobacterium bifidum, Bifidobacterium breve, Bifidobacterium infantis, Bifidobacterium longum, Enterococcus faecium, Escherichia coli Nissle 1917, Streptococcus salivarus subsp Thermophilus, Saccharomyces boulardii and the like. In some exemplary embodiments, the probiotic microbial strains are selected from the group comprising Lactobacillus helveticus, Lactobacillus acidophilus, Lactobacillus rhamnosus GG, Streptococcus thermophilus or Lactobacillus bulgaricus.

Inclusion of one or more probiotic microbial strains in a beverage according to some exemplary embodiments of the invention may provide a nutritional benefit to the subject consuming the beverage, and may benefit athletic performance. Probiotics may enhance the immune response in a fatigued athlete, and may further provide secondary health benefits that may positively affect athletic performance, for example, an overall state of good general health, enhanced recovery from fatigue, improved immune function and/or maintenance of healthy gastrointestinal tract function. If present, the probiotic microbial strains (“probiotics”) may comprise from about 0.0004% to about 0.01% w/w of the beverage.

A beverage according to some exemplary embodiments may further comprise one or more of a stabilizer or thickener, a vitamin and mineral mixture, electrolytes, an emulsifier, a flavour additive, a colour additive, a sweetener, a carbohydrate source, or the like.

Examples of stabilizers or thickeners include agar, pectin, lecithin, egg yolk, soy lecithin, carrageenan, locust bean gum, gelatin, xanthan gum, alginin, guar gum, sodium pyrophosphate and mixtures thereof.

Examples of vitamins that may be included in a vitamin and mineral mixture include one or more of vitamins A, C, D, E, K, B6 or B12; thiamine, riboflavin, folic acid, pantothenic acid, niacin, biotin, inositol and choline. Examples of minerals that may be included in a vitamin and mineral mixture include one or more of calcium, iron, manganese, chloride, phosphorus, iodine, magnesium, zinc, copper, sodium, potassium, chromium, molybdenum, and selenium, or salts thereof.

Examples of electrolytes include potassium, sodium, calcium and the like.

Examples of emulsifiers include lecithin, mono-diglycerides, di-glycerides, gum acacia (gum arabic), modified food starches (e.g., alkenylsuccinate modified food starches), anionic polymers derived from cellulose (e.g., carboxymethylcellulose), gum ghatti, modified gum ghatti, xanthan gum, tragacanth gum, guar gum, locust bean gum, pectin, and mixtures thereof.

Examples of flavour additives include fruit juice, fruit flavors, botanical flavors, and mixtures thereof. Where fruit juice is included, the beverage may comprise from about 1% to about 20%, fruit juice. The fruit juice may be any suitable juice, for example grapefruit, orange, lemon, lime, mandarin, apple, cranberry, pear, peach, plum, apricot, nectarine, grape, cherry, currant, raspberry, gooseberry, elderberry, blackberry, blueberry, strawberry, pineapple, coconut, pomegranate, kiwi, mango, papaya, banana, watermelon, passion fruit, tangerine, cantaloupe, guava, or a combination thereof.

Fruit flavors may also be utilized, fruit flavors may be derived from natural sources such as essential oil and extracts, or can be synthetically prepared. Fruit flavors may be derived from fruits through processing, particularly concentrating.

Coffee or tea, or extracts or solids of coffee or tea may also be used to flavour beverages according to some embodiments of the invention. Where coffee solids are included, the compositions may comprise from about 1 to about 10% coffee solids, by weight of the composition. Where tea solids are included, the compositions of the present invention may comprise from about 0.01% to about 2% by weight of the composition, of tea solids. The term “tea solids” refers to solids extracted from tea materials including those materials obtained from the genus Camellia (e.g. C. sinensis and C. assaimic); such materials may include fresh leaves, fresh leaves that have been dried, or heat treated before drying, unfermented tea leaves, instant green tea, or partially fermented tea leaves. Green tea solids include tea leaves, tea plant stems, and other plant materials that are related and which have not undergone substantial fermentation to create black teas.

Examples of colour additives or coloring agents include natural or artificial colors. For example FD&C dyes (e.g., yellow #5, blue #2, red #40) may be used. Natural coloring agents may include fruit and vegetable juices, riboflavin, carotenoids (for example, beta-carotene), turmeric, and lycopenes. The exact amount of coloring agent used will vary, depending on the agents used and the intensity desired in the finished composition. Generally, if utilized, the coloring agent is typically present at a level of from about 0.0001% to about 0.5%, by weight of the composition.

Examples of sweeteners and carbohydrate sources include sugar, glucose, fructose, sucrose, liquid sucrose, maltodextrin, corn syrup solids, high fructose corn syrup, corn syrup, a soluble fiber, pectin, trehalose, isomaltulose, or combinations thereof. In some embodiments, the sweetener may be a no-calorie, or low-calorie sweetener.

Examples of no-calorie, or low-calorie sweeteners include sucralose, saccharine, cyclamates, L-aspartyl-L-phenylalanine lower alkyl ester sweeteners (e.g., aspartame), aspartamine, acesulfame K, sorbitol, glycyrrhizins, sucralose, suosan, miraculin, monellin, sorbitol, xylitol, stevia, steviosides, sweet glycosides or the like.

In some embodiments the sweetener or carbohydrate source may be a sugar or polysaccharide that is slowly digested, thus prolonging digestion and providing a lower insulinogenic response. Examples of such slow-digested sugars may include, but are not limited to, isomalt, isomaltulose, trehelose, D-tagatose, tapioca dextrin, and sucromalt.

Water may also be included in a beverage according to one or more exemplary embodiments. Water may be added as a separate reagent, or included as a portion of another component e.g. reconstituted dried milk, a diluent of a flavour or colour vehicle, moisture content of a component (e.g. in an egg product), and may be present in an amount of about 20% to about 99%, or any amount therebetween, for example about 30% to about 90%, or about 40% to about 80%, or about 50% to about 75% or any amount therebetween.

Quantities of components of a beverage according to exemplary embodiments of the present invention may be described as absolute values (e.g. 200 grams, 50 ml or the like), or with respect to a volume of the beverage (e.g. 5 grams per 100 ml), or with respect to a serving size of the beverage (e.g. 50 milligrams per serving). A serving, or serving size, may be a volume of about 100 ml to about 500 ml, or any amount therebetween, for example 150, 200, 250, 300, 350, 400 or 450 ml, or any amount therebetween.

The present invention also relates to methods of making a fermented beverage comprising a milk product and an egg product.

The present invention also relates to methods of making a beverage comprising a fermented milk product an and egg product.

In one exemplary embodiment, the method comprises combining a culture base with a stabilizer blend. The culture base may comprise from about 20% to about 90% (w/w) of the beverage, or any amount therebetween; for example from about 25% to about 75%, or from about 30% to about 70%, or from about 40% to about 60%, or about 45% to about 55%, or any amount therebetween. In one embodiment, the culture base comprises about 20-25% w/w, or about 35-40% w/w.

The culture base may be prepared by homogenizing a fluid milk, adding a yogurt mother, or mother culture to about 5% w/w, and incubating the combined fluid milk and yogurt mother at a suitable incubation temperature until a suitable pH is reached. A suitable incubation temperature may be about 30° C. to about 45° C., or any temperature therebetween, for example, 31, 32, 33, 34, 35, 36, 37, 38, 39, 40, 41, 42, 43 or 44° C., or any temperature therebetween. A suitable pH may be about 4.0 to about 4.8 or any pH therebetween, such as 4.2, 4.3. 4.4, 4.5 or 4.6, or any pH therebetween. Optionally, the culture base may be homogenized and/or pasteurized following incubation, using conventional methods. Pasteurization may be performed, for example, using conventional methods, at a temperature of about 80° C. to about 95° C., or any temperature therebetween, and for about 10 seconds to about 30 minutes, or any period therebetween. Homogenization may be performed using conventional methods, for example as a one-stage, or a two-stage process. Exemplary pressure ranges for a one-stage homogenization may be from about 2,000 to about 3,000 psig, or any amount therebetween. Exemplary pressure ranges for a two-step homogenization may be from about 1,500 to about 2,500 psig for the first stage, and from about 300 to about 500 psig for the second stage.

The yogurt mother may comprise one or more microbial strains capable of fermenting lactose and producing lactic acid. In some embodiments, the microbial strain may be a probiotic microbial strain. The microbial strains may be acquired from a commercial source, or may be naturally occurring (e.g. fresh fluid milk is colonized by planktonic, or ambient, microbial strains in the environment); alternately, the microbial strains may be introduced to the fluid milk by an aliquot of a previous batch of yogurt, fermented milk product, or yogurt mother. In an exemplary embodiment, the yogurt mother comprises Streptococcus thermophilus, Lactobacillus bulgaricus or a combination thereof.

The stabilizer blend may be prepared by dry-blending any dry ingredients. Liquid ingredients are also combined, and the blended dry ingredients mixed to homogeneity with the blended liquid ingredients. The liquid ingredients may be heated to aid in mixing, and may be cooled before combining with the dry ingredients. The resulting stabilizer blend may subsequently be pasteurized and/or homogenized as described above, and cooled until needed.

In one exemplary embodiment of the invention, the beverage comprises the components according to Table 1:

TABLE 1
Percent w/w of components of exemplary
embodiments of the beverage

| Product component | Ingredient | % (w/w) | % (w/w) |
|---|---|---|---|
| Cultured Base | | | 20-90 |
| | Skim Milk Powder | 10-18 | |
| | Water | 70-88 | |
| | Mother Culture | 2-6 | |
| Stabilizer Blend | | | 10-80 |
| | Maltodextrin | 2-15 | |
| | Sugar | 2-15 | |
| | Skim Milk Powder | 2-10 | |
| | Pectin | 0.1-1 | |
| | Egg Yolk | 5-15 | |
| | colour agent | 0.001-0.5 | |
| | flavour agent | 0.01-20 | |
| | Water | 50-70 | |
| Probiotics | | | 0.0004-0.01% |

In some embodiments, the culture base may comprise from about 60% to about 65%, or any amount therebetween of the beverage, and the stabilizer blend from about 35% to about 40% or any amount therebetween, of the beverage. In some embodiments, the culture base may comprise from about 12% to about 15%, or any amount therebetween of skim milk powder; and from about 75% to about 83%, or any amount therebetween of water; and from about 1% to about 6%, or any amount therebetween of mother culture. In some embodiments, the stabilizer blend may comprise from about 8% to about 15%, or any amount therebetween, of maltodextrin; and from about 6% to about 15%, or any amount therebetween of sugar; and from about 5% to about 6%, or any amount therebetween of skim milk powder; and from about 0.15% to about 0.5%, or any amount therebetween of pectin; and from about 11% to about 13%, or any amount therebetween of egg yolk; and from about 0.001% to about 0.5% or any amount therebetween of colour agent; and from about 0.01% to about 20% or any amount therebetween of flavour agent; and from about 55% to about 70%, or any amount therebetween of water.

The present invention will be further illustrated in the following examples. However it is to be understood that these examples are for illustrative purposes only, and should not be used to limit the scope of the present invention in any manner.

### Example 1

Trial 1 evaluated a basic product formulation and targeted the required ingredients and active ingredient levels. This trial assisted in determining processing parameters and level of ingredients required. Tables 2-5 provide the quantities of the components of the cultured milk base, stabilizer blend and final beverage composition.

TABLE 2
Culture milk base composition:

| | % | | Total | Total | | | Carb | Vitamin | Carbs/ |
|---|---|---|---|---|---|---|---|---|---|
| Ingredients | w/w | Moisture % | Fat % | Protein % | MSNF* % | Lactose % | total % | D % | Protein % |
| Skim Milk | 18.27 | 3.16 | 0.77 | 36.16 | 96.07 | 51.98 | 51.98 | 0.0000088 | 1.44 |
| Powder, | | | | | | | | | |
| Low Temp. | | | | | | | | | |
| Water | 76.73 | 100.00 | 0.00 | 0.00 | 0.00 | 0.00 | 0.00 | | |
| mother | 5.00 | 90.80 | 0.18 | 3.41 | 9.02 | 4.85 | 4.85 | | 1.42 |
| culture | | | | | | | | | |
| (Abiasa | | | | | | | | | |
| Yogotherm | | | | | | | | | |
| Culture), | | | | | | | | | |
| diluted** | | | | | | | | | |

*MSNF = Milk Solids Not Fat
**2.5 g per litre

TABLE 3
Stabilizer blend composition

| | % | | Total | Total | | | | | Carb. | Egg | Vitamin |
|---|---|---|---|---|---|---|---|---|---|---|---|
| Ingredients | w/w | Moisture % | Fat % | Prot. % | MSNF* % | Lactose % | Sugar % | Maltodextrin % | Total % | Yolk % | D % |
| Star-Dri 100 | 4.89 | 5.00 | | 0.30 | | | 3.50 | 91 | 94.20 | | |
| Maltodextrin | | | | | | | | | | | |
| Sugar | 5.29 | 0.04 | 0.00 | 0.00 | 0.00 | 0.00 | 100.00 | | 99.96 | | |
| Pasteurized | 7.21 | 56.20 | 24.60 | 15.50 | | | 0.20 | | 1.50 | 100.00 | 0.0000027 |
| Egg Yolk | | | | | | | | | | | |
| (Burnbrae) | | | | | | | | | | | |
| Pectin Classic | 0.30 | 8.00 | 0.00 | | 0.00 | 0.00 | 14.00 | | 77.00 | | |
| CM 203 | | | | | | | | | | | |
| Water | 82.31 | 100.00 | 0.00 | 0.00 | 0.00 | 0.00 | | | 0.00 | | |

TABLE 4
Final beverage blend - component makeup

| | % | | Total | Total | | | | | Carb. | Egg | Vitamin | Carb/ |
|---|---|---|---|---|---|---|---|---|---|---|---|---|
| | w/w | Moisture % | Fat % | Prot. % | MSNF* % | Lactose % | Sugar % | Maltodextrin % | Total % | yolk % | D % | Protein |
| Cultured | 24.46 | 81.85 | 0.15 | 6.78 | 18.00 | 9.74 | 0.00 | 0.00 | 9.74 | 0 | 0.00 | |
| Base | | | | | | | | | | | | |
| Stabilizer | 74.43 | 86.63 | 1.77 | 1.13 | 0.00 | 0.00 | 5.52 | 4.43 | 10.24 | 7.21 | 0.00 | |
| Solution | | | | | | | | | | | | |
| Lactobacillus | 0.06 | 90.80 | 0.18 | 3.41 | 9.02 | 4.85 | | | 4.85 | | | 1.42 |
| helveticus | | | | | | | | | | | | |
| R52 diluted | | | | | | | | | | | | |
| Lactobacillus | 1.06 | 90.80 | 0.18 | 3.41 | 9.02 | 4.85 | | | 4.85 | | | 1.42 |
| rhamnosus | | | | | | | | | | | | |
| R11 diluted | | | | | | | | | | | | |

TABLE 5
Final beverage composition in Trial 1

| Final Mix | calculated | Calculated | Target | Target |
|---|---|---|---|---|
| Composition | (% w/w) | (g) | Min (g)* | Max (g)* |
| Moisture | 84.5 | 253.5 | 0 | 300 |
| Total Fat | 1.36 | 4.07 | 3 | 300 |
| Total Prot | 2.5 | 7.5 | 7 | 7.5 |
| MSNF | 4.4 | 13.21 | 0 | 300 |
| Lactose | 2.38 | 7.14 | 0 | 300 |
| Sugar | 4.11 | 12.33 | 0 | 300 |
| Maltodextrin | 3.3 | 9.9 | 0 | 300 |
| Carb total | 10 | 30 | 0 | 300 |
| Egg Yolk | 5.37 | 16.1 | 16.1 | 16.1 |
| Vitamin D (IU) | 0.000001 | 64.41 | 0 | 300 |
| Carb/Protein | 4 | 4 | 4 | 10 |
| Lactose/Carb | 0.24 | 0.24 | 0 | 1 |
| Sugar/Carb | 0.41 | 0.41 | 0 | 0.33 |
| Maltodextri/Carb | 0.33 | 0.33 | 0 | 0.33 |
| Ash | 0.39 | 1.17 | 0 | 300 |

*For a 300 g serving size

TABLE 6
pH and temperature of cultured milk.

| Time (Hours) | Temperature | pH |
|---|---|---|
| 0.0 | 40 | 6.12 |
| 1.9 | 40 | 5.5 |
| 2.9 | 39 | 4.86 |
| 3.1 | 40 | 4.82 |
| 3.6 | 40 | 4.68 |
| 4.1 | 40 | 4.53 |
| 4.2 | 40 | 4.48 |

Yogurt mother (mother culture) Preparation: Skim milk was batch pasteurized (9° C./30 min) and cooled to 38-39° C. The required quantity of pasteurized, skim milk for first dilution was transfered to a clean, sanitized, stainless steel pot, and 10 g of culture (Abiasa Yogotherm™) per 2 litre of milk.

Cultured milk base (yogurt base) preparation (Table 2): Fluid milk (fresh or reconstituted) was warmed to approximately 30° C., and any dry ingredients added and mixed thoroughly. The resulting fluid milk mixture was batch pasteurized (85° C./30 minutes) and cooled to 39° C. Diluted mother culture was added and mixed thoroughly, and held at 38-39° C. without agitation until desired pH was reached (about pH 4.4-4.5 for this trial)—see Table 6 for pH and temperature during the fermentation process. The cultured milk was again agitated, and cooled to 10° C.

The average temperature during the culturing was 39.3 (std dev 0.4). Fermentation was stopped at 4.2 hours (pH 4.48).

Stabilizer blend preparation (Table 3): Dry ingredients (maltodextrin, sugar and pectin) were dry-blended and then reconstituted in water. Egg yolk was blended into the maltodextrin/sugar/pectin mixture (5,000 rpm for 2 minutes), and the resulting mix homogenized at 60° C., 2,500 psig (1^{st} stage)/500 psig (2^{nd} stage), followed by pasteurization at 75° C. for 10 minutes and immediate cooling to 5-10° C.

Final beverage blend for Trial 1 (Tables 4, 5): cultured milk base (prepared as above), stabilizer blend (prepared as above) and probiotic microbial strains (L. helveticus and L. rhamnosus) were combined and mixed until homogeneous. The final beverage was bottled and evaluated for texture and flavour.

A significant amount of foaming was observed during the initial trial. This may have been due to the type of skim milk powder utilized in the formulation, and it was considered that a fortified, low temperature skim milk powder may be suitable for subsequent trials.

The trial 1 samples were described as having an “eggy” flavour, significant sour taste and a consistency that was “too thin”. It was considered that subsequent trials may include and evaluate masking agents (to mask the egg flavour), alter sugar or other sweetener levels (to address sour notes), and/or increase in pectin (to improve texture/consistency), while targeting the required ingredient and active ingredient levels.

Component levels were also considered, to provide suitable levels of protein, carbohydrate, fat, electrolytes and the like. Component targets for a 300 mL serving were: 16.1 g egg yolk and carbohydrate:protein 4:1.

### Example 2

Following consultations regarding nutrient levels, active ingredients useful for inclusion in an ‘athletic recovery beverage’, a second formulation was developed and tested. Trial 2 evaluated a modified product formulation with added flavours (chocolate and vanilla).

Tables 11-13 set out the individual formulations for the Culture base, Stabilizer blend and combined culture base and stabilizer blend in the final beverage for each of the 5 trials, along with the ranges of the products and the specific ingredient changes. The adjustments made to the formulation in Trial 2, and subsequent alterations for trials 3, 4 and 5 are set out therein.

### Stabilizer Blend Preparation Procedure (Used for Trials 2-5)

1. Mix eggs with sugar until well blended.
2. Slowly add water to egg-sugar mixture and mix until well blended.
3. Add flavour and colour to water-egg-sugar mixture.
4. Dry blend maltodextrin, pectin, and skim milk powder (ensure pectin is well dispersed to avoid clumping).
5. Add dry blend to water-egg-sugar mixture, and mix until well blended.
6. Homogenize stabilizer blend at 55° C. using a two step homogenization (2,500+500 psi).
7. Pasteurize stabilizer blend at 75° C., hold for 10 minutes.
8. Cool to 4-10° C.

A mother culture for Trial 2, and used in trials 3-5 was made in the same manner as that for Trial 1, with Streptococcus thermophilus AD200 and Lactobacillus delbrueckii subsp. bulgaricus AD50 at 2.5 g each per liter of milk used as inoculant.

The product of Trial 2 was deemed to have a sour flavour, which was not within the desired taste preferences. It was considered that subsequent formulations may include yogurt with a higher pH.

Component targets were altered for Trial 2. For a 350 mL serving size, the targets were: 15 g protein, 50 g carbohydrate, and 16.1 g egg yolk. Component targets for Trial 2 were met

Use of milk protein concentrate in place of a portion of the skim milk powder was considered for subsequent formulations, to increase protein content and increase osmolality.

Flavours (chocolate and vanilla) were considered and evaluated. Following evaluations, it was determined that chocolate and vanilla flavours did not blend well together with the flavour provided by the yogurt product. Fruit flavours were recommended for subsequent formulations

### Example 3

The formulation for trial #3 aimed to provide a sweeter, more flavourful refreshing product, reduce the overall acidity, maintain nutritional targets, and consider the use of milk protein concentrate to achieve an acceptable level of osmolality. To increase sweetness, the percent sugar and maltodextrin were increased in the stabilizer blend. To reduce the degree of acidity, skim milk powder was reduced in the cultured milk base and, increased in the stabilizer blend.

The pH of the cultured milk base was also modified. Two batches of cultured milk base were produced for this trial. Fermentation of batch A of the cultured milk base was stopped at pH 4.38 whereas fermentation of batch B of the cultured milk base was stopped at pH 4.32. Batch B cultured milk base was used in trial #3, at a cultured milk base/stabilizer blend ratio of 65% cultured milk base and 35% stabilizer blend.

The product comprising either batch A or B of the cultured milk base was considered to be too tart and too acidic. The viscosity of the product was acceptable, however increasing the pectin was considered to improve texture.

### Example 4

Batch A of the cultured milk base (from Example 3) was used to conduct a fourth trial. For this trial, the percentage of sugar in the stabilizer blend was increased and the ratio of cultured milk base and stabilizer blend was changed to 60% cultured milk base and 40% stabilizer blend. From this mix, three flavour samples were provided, and five colour samples were provided for evaluation.

Sweetness was still considered to be insufficient, however a ‘wild berry’ flavour was deemed suitable.

### Example 5

Trials #5A and #5B aimed to further investigate the level of sweetness of the product. Trial #5A increased the amount of sugar and decreased the amount of maltodextrin, whereas Trial #5B increased the amount of sugar (more than that of Trial #5A) and removed all of the maltodextrin. Both formulas included the same percentage of flavour and colour, and maintained the requested nutritional targets. Products from Trial #5A (DEV 1764-DX3-5A) and #5B (DEV 1764-DX3-5B) were packaged and evaluated for colour/colour intensity preference. As the colour of the product of Trial 5A was lighter than anticipated, it was considered to increase the colouring agent further when conducting scale-up trials.

The product of the 5A trial was considered to be less sweet, and was the preferred product of the two considered.

The composition of the final formulation 5A is shown in Table 7. The quantities of the components of the Culture base, stabilizer blend and the final beverage composition of Trial 5 are set out in Tables 8-10.

Over the course of the five trials described above, the quantities of selected formulation components were altered to achieve desired qualities with respect to taste, texture, advantageous processing or the like. Tables 11-13 set out the individual formulations for the Culture base, Stabilizer blend and combined culture base and stabilizer blend in the final beverage for each of the 5 trials, along with the ranges of the products and the specific ingredient changes.

Table 14 sets out the composition for each of the 5 trials for the moisture, fat, total protein, milk solids, lactose, sugar, maltodextrin, carbohydrates and egg yolk, and Table 15 sets out the changes in composition between the trials 1 to 5 for moisture, fat, total protein, milk solids, lactose, sugar, maltodextrin, carbohydrates and egg yolk.

TABLE 7
Composition of Final beverage formulation (350 ml serving size).

| | Per | per | | Per | Per |
|---|---|---|---|---|---|
| Nutrient | serving | 100 g | Nutrient | Serving | 100 g |
| | | | Biotin (mcg) | 0.60 | 0.17 |
| Calories (kcal) | 296.99 | 84.85 | Vitamin C (mg) | 1.99 | 0.57 |
| Calories from Fat (kcal) | 39.27 | 11.22 | Vitamin D - IU (IU) | 147.60 | 42.17 |
| Calories from SatFat (kcal) | 12.74 | 3.64 | Vitamin D - mcg (mcg) | 3.78 | 1.08 |
| Protein (g) | 14.68 | 4.19 | Vitamin E - Alpha-Toco | 0.40 | 0.12 |
| | | | (mg) | | |
| Carbohydrates (g) | 50.13 | 14.32 | Folate (mcg) | 18.67 | 5.34 |
| Dietary Fiber (g) | 0.45 | 0.13 | Folate, DFE (mcg) | 35.45 | 10.13 |
| Soluble Fiber (g) | 0.45 | 0.13 | Vitamin K (mcg) | 0.11 | 0.03 |
| Total Sugars (g) | 44.33 | 12.67 | Pantothenic Acid (mg) | 1.65 | 0.47 |
| Monosaccharides (g) | 0 | 0 | Minerals | | |
| Disaccharides (g) | 0 | 0 | Calcium (mg) | 458.35 | 130.96 |
| Other Carbs (g) | 5.34 | 1.53 | Chromium (mcg) | 0.13 | 0.04 |
| Fat (g) | 4.36 | 1.25 | Copper (mg) | 0.04 | 0.01 |
| Saturated Fat (g) | 1.42 | 0.40 | Fluoride (mg) | 0.21 | 0.06 |
| Mono Fat (g) | 1.63 | 0.47 | Iodine (mcg) | 21.73 | 6.21 |
| Poly Fat (g) | 0.59 | 0.17 | Iron (mg) | 0.67 | 0.19 |
| Trans Fatty Acid (g) | 0 | 0 | Magnesium (mg) | 43.44 | 12.41 |
| Cholesterol (mg) | 179.30 | 51.23 | Manganese (mg) | 0.02 | 0.00 |
| Water (g) | 267.96 | 76.56 | Molybdenum (mcg) | — | — |
| Vitamins | | | Phosphorus (mg) | 397.60 | 113.60 |
| Vitamin A - IU (IU) | 259.01 | 74.00 | Potassium (mg) | 595.42 | 170.12 |
| Vitamin A - RE (RE) | 75.49 | 21.57 | Selenium (mcg) | 16.04 | 4.58 |
| Vitamin A - RAE (RAE) | 307.54 | 87.87 | Sodium (mg) | 216.23 | 61.78 |
| Vitamin A - Carotenoid RE | 3.22 | 0.92 | Zinc (mg) | 1.94 | 0.56 |
| (RE) | | | | | |
| Vitamin A - Retinol RE (RE) | 305.93 | 87.41 | Other Fats | | |
| Beta-Carotene (mcg) | 14.02 | 4.01 | Omega 3 Fatty Acid (g) | 0.04 | 0.01 |
| Vitamin B1 - Thiamin (mg) | 0.16 | 0.05 | Omega 6 Fatty Acid (g) | 0.54 | 0.15 |
| Vitamin B2 - Riboflavin (mg) | 0.67 | 0.19 | Other Nutrients | | |
| Vitamin B3 - Niacin (mg) | 0.31 | 0.09 | Gram Weight (g) | 350.00 | 100.00 |
| Niacin Equivalents (mg) | 3.56 | 1.02 | Alcohol (g) | 0 | 0 |
| Vitamin B6 (mg) | 0.17 | 0.05 | Caffeine (mg) | 0 | 0 |
| Vitamin B12 (mcg) | 1.63 | 0.47 | Choline (mg) | 109.83 | 31.38 |

TABLE 8
Culture milk base composition from Trial 5:

| | % | | Total | Total | | | Carb |
|---|---|---|---|---|---|---|---|
| Ingredients | w/w | Moisture % | Fat % | Protein % | MSNF* % | Lactose % | total % |
| Skim Milk Powder, Low | 12.02 | 3.16 | 0.77 | 36.16 | 96.07 | 51.98 | 51.98 |
| Temp. | | | | | | | |
| Water | 82.98 | 100.00 | 0.00 | 0.00 | 0.00 | 0.00 | 0.00 |
| mother culture, diluted | 5.00 | 90.80 | 0.18 | 3.41 | 9.02 | 4.85 | 4.85 |

*MSNF = Milk Solids Not Fat

TABLE 9
Stabilizer blend composition from Trial 5

| | % | | Total | Total | | | | Carb. | Egg |
|---|---|---|---|---|---|---|---|---|---|
| Ingredients | w/w | Moisture % | Fat % | Prot. % | MSNF* % | Lactose % | Sugar % | Total % | Yolk % |
| Star-Dri 100 | 4.00 | 5.00 | | 0.30 | | | 10.0 | 94.20 | |
| Maltodextrin | | | | | | | | | |
| Sugar | 18.58 | 0.04 | 0.00 | 0.00 | 0.00 | 0.00 | 99.96 | 99.96 | |
| Skim Milk | 5.93 | 3.16 | 0.77 | 36.16 | 96.07 | 51.98 | 51.98 | 51.98 | |
| Powder, Low | | | | | | | | | |
| Temp. | | | | | | | | | |
| Pasteurized | 11.5 | 56.20 | 24.60 | 15.50 | | | | 1.50 | 100.00 |
| Egg Yolk | | | | | | | | | |
| (Burnbrae) | | | | | | | | | |
| Pectin Classic | 0.5 | 8.00 | 0.00 | | 0.00 | 0.00 | 14.00 | 77.00 | |
| CM 203 | | | | | | | | | |
| Exberry | 0.1 | | | | | | | | |
| Shade | | | | | | | | | |
| Bordeaux | | | | | | | | | |
| Givaudan | 0.3 | | | | | | | | |
| Flavour KC- | | | | | | | | | |
| 989-481-9 | | | | | | | | | |
| Water | 59.09 | 100.00 | 0.00 | 0.00 | 0.00 | 0.00 | | 0.00 | |

TABLE 10
Final beverage blend - component makeup from Trial 5

| | | | Total | Total | | | | Carb. | Egg |
|---|---|---|---|---|---|---|---|---|---|
| | % w/w | Moisture % | Fat % | Prot. % | MSNF* % | Lactose % | Sugar % | Total % | yolk % |
| Cultured | 60.00 | 87.690 | 0.10 | 4.52 | 12.00 | 6.49 | 6.49 | 6.49 | 0 |
| Base | | | | | | | | | |
| Stabilizer | 39.99 | 65.98 | 2.88 | 3.94 | 5.70 | 3.08 | 22.06 | 25.98 | 11.50 |
| Blend | | | | | | | | | |
| L. helveticus | 0.00048 | 90.80 | 0.18 | 3.41 | 9.02 | 4.85 | | 4.85 | |
| R52 diluted | | | | | | | | | |
| L. rhamnosus | 0.00905 | 90.80 | 0.18 | 3.41 | 9.02 | 4.85 | | 4.85 | |
| R11 diluted | | | | | | | | | |

*MSNF = Milk Solids Not Fat

TABLE 11
Formulations and changes over trials 1-5 for Cultured Base.

| | | | | | | Ingredient | | Ingredient Changes | | | |
|---|---|---|---|---|---|---|---|---|---|---|---|
| | PRODUCT FORMULATIONS | | | | | Range (Trials | | Trial To Trial | | | |
| | % w/w | | | | | 2-5) | | Trial 1 | Trial 2 | Trial 3 | |
| | Trial 1 | Trial 2 | Trial 3 | Trial 4 | Trial 5 | Min. | Max. | to 2 | to 3 | to 4 | Trial 4 to 5 |
| Sugar | | 5.06% | | | | 5.06% | 5.06% | 5.06% | −5.06% | 0.00% | 0.00% |
| Skim Milk | 18.27% | 15.35% | 12.02% | 12.02% | 12.02% | 12.02% | 18.27% | −2.91% | −3.33% | 0.00% | 0.00% |
| Powder, | | | | | | | | | | | |
| Low | | | | | | | | | | | |
| Temp. | | | | | | | | | | | |
| Water | 76.73% | 74.59% | 82.98% | 82.98% | 82.98% | 74.59% | 82.98% | −2.15% | 8.39% | 0.00% | 0.00% |
| Abiasa | 5.00% | 5.00% | 5.00% | 5.00% | 5.00% | 5.00% | 5.00% | 0.00% | 0.00% | 0.00% | 0.00% |
| Yogurt | | | | | | | | | | | |
| Cultures*, | | | | | | | | | | | |
| diluted | | | | | | | | | | | |
| Total | 100.00% | 100.00% | 100.00% | 100.00% | 100.00% | 100.00% | 100.00% | 0.00% | 0.00% | 0.00% | 0.00% |

TABLE 12
Formulations and changes over trials 1-5 for Stabilizer Blend.

| | | | | | | Ingredient Range | | Ingredient Changes Trial To Trial | | | |
|---|---|---|---|---|---|---|---|---|---|---|---|
| | PRODUCT FORMULATIONS % w/w | | | | | (Trials 2-5) | | Trial | Trial | | |
| | Trial 1 | Trial 2 | Trial 3 | Trial 4 | Trial 5 | Min. | Max. | 1 to 2 | 2 to 3 | Trial 3 to 4 | Trial 4 to 5 |
| Star-Dri 100 | 4.89% | 10.00% | 14.65% | 7.82% | 7.82% | 4.89% | 14.65% | 5.11% | 4.65% | −6.83% | 0.00% |
| Maltodextrin | | | | | | | | | | | |
| Sugar | 5.29% | 6.63% | 12.11% | 15.00% | 15.00% | 5.29% | 15.00% | 1.34% | 5.47% | 2.89% | 0.00% |
| Skim Milk | | | 4.91% | 5.90% | 5.90% | 4.91% | 5.90% | 0.00% | 4.91% | 0.99% | 0.00% |
| Powder, | | | | | | | | | | | |
| Low | | | | | | | | | | | |
| Temp. | | | | | | | | | | | |
| Pectin | 0.30% | 0.15% | 0.15% | 0.500% | 0.500% | 0.15% | 0.50% | −0.15% | 0.00% | 0.35% | 0.00% |
| Classic | | | | | | | | | | | |
| CM 203 | | | | | | | | | | | |
| Pasteurized | 7.21% | 12.50% | 13.15% | 11.50% | 11.50% | 7.21% | 13.15% | 5.29% | 0.65% | −1.64% | 0.00% |
| Egg | | | | | | | | | | | |
| Yolk | | | | | | | | | | | |
| (Burnbrae) | | | | | | | | | | | |
| Water | 82.31% | 70.72% | 55.04% | 59.28% | 59.28% | 55.04% | 82.31% | −11.59% | −15.68% | 4.24% | 0.00% |
| Total | 100.00% | 100.00% | 100.00% | 100.00% | 100.00% | 100.00% | 100.00% | 0.00% | 0.00% | 0.00% | 0.00% |

TABLE 13
Formulations and changes over trials 1-5 for Cultured Base + Stabilizer blend.

| | PRODUCT FORMULATIONS | | | | | Ingredient Range | | Ingredient Changes Trial To Trial | | | |
|---|---|---|---|---|---|---|---|---|---|---|---|
| | % w/w | | | | | (Trials 2-5) | | Trial 1 | Trial 2 | | |
| | Trial 1 | Trial 2 | Trial 3 | Trial 4 | Trial 5 | Min. | Max. | to 2 | to 3 | Trial 3 to 4 | Trial 4 to 5 |
| Cultured | 24.46% | 62.25% | 65.00% | 60.00% | 60.00% | 24.46% | 65.00% | 37.79% | 2.75% | −5.00% | 0.00% |
| Base | | | | | | | | | | | |
| Stabilizer | 74.43% | 36.80% | 34.99% | 39.99% | 39.99% | 34.99% | 74.43% | −37.63% | −1.81% | 5.00% | 0.00% |
| Blend | | | | | | | | | | | |
| L. acidophilus | 0.06% | 0.05% | 0.00048% | 0.00048% | 0.00048% | 0.00% | 0.06% | −0.01% | −0.05% | 0.00% | 0.00% |
| R52 | | | | | | | | | | | |
| L. rhamnosus | 1.06% | 0.90% | 0.00905% | 0.00905% | 0.00905% | 0.01% | 1.06% | −0.15% | −0.90% | 0.00% | 0.00% |
| R11 | | | | | | | | | | | |
| Total | 100.00% | 100.00% | 100.00% | 100.00% | 100.00% | 100.00% | 100.00% | 0.00% | 0.00% | 0.00% | 0.00% |

TABLE 14
Final Beverage Composition (calculated)

| | | | | Milk | | | | | |
|---|---|---|---|---|---|---|---|---|---|
| | | | | Solids | | | | | |
| Final Mix Composition | | | | Non- | | | | | Egg |
| (calculated) | Moisture | Fat | Protein | Fat | Lactose | Sugar | Maltodextrin | Carbohydrate | Yolk |
| Trial 1 | 78.36% | 1.21% | 4.29% | 9.46% | 5.12% | 5.59% | 3.34% | 14.29% | 4.60% |
| Trial 2 | 78.36% | 1.21% | 4.29% | 9.46% | 5.12% | 5.59% | 3.34% | 14.29% | 4.60% |
| Trial 3 | 79.29% | 1.21% | 4.29% | 9.45% | 5.11% | 5.13% | 4.65% | 14.29% | 4.60% |
| Trial 4 | 79.28% | 1.21% | 4.29% | 9.47% | 5.12% | 6.00% | 2.84% | 14.29% | 4.60% |
| Trial 5 | 79.28% | 1.21% | 4.29% | 9.47% | 5.12% | 6.00% | 2.84% | 14.29% | 4.60% |

TABLE 15
Beverage Composition changes Trial to Trial

| | | | | Milk | | | | | |
|---|---|---|---|---|---|---|---|---|---|
| Composition Changes | | | | Solids | | | | | Egg |
| Trial To Trial | Moisture | Fat | Protein | Non-Fat | Lactose | Sugar | Maltodextrin | Carbohydrate | Yolk |
| Trial 1 to 2 | 0.00% | 0.00% | 0.00% | 0.00% | 0.00% | 0.00% | 0.00% | 0.00% | 0.00% |
| Trial 2 to 3 | −0.94% | 0.00% | 0.00% | 0.01% | 0.01% | 0.46% | −1.31% | 0.00% | 0.00% |
| Trial 3 to 4 | 0.01% | 0.00% | 0.00% | −0.02% | −0.01% | −0.87% | 1.81% | 0.00% | 0.00% |
| Trial 4 to 5 | 0.00% | 0.00% | 0.00% | 0.00% | 0.00% | 0.00% | 0.00% | 0.00% | 0.00% |

### Example 6

### Scale-Up Trials

### Yogurt Mother Preparation:

1. Batch pasteurize a predetermined amount of skim milk at 90° C. for 6 minutes
2. Cool skim milk to 39° C.
3. Dispense required quantity of skim milk for first dilution to a clean, sanitized, stainless steel pot
4. Dispense at a rate of 2.5 g/litre of skim milk each of the yogurt cultures, using sanitized equipment
   Streptococcus thermophilus AD 200 (Abiasa)
   Lactobacillus bulgaricus AD50 (Abiasa)
5. Incubate mother culture at 39° C. until pH 4.5 is attained
6. Agitate the mother culture once pH 4.5 is achieved and immediately cool to 5° C.
7. Refrigerate mother culture until ready to use in cultured milk base

TABLE 16
DEV 1764-DX3-5A, Cultured Milk base

| Ingredient | Supplier | Supplier Code | % w/w |
|---|---|---|---|
| Skim Milk Powder, | Gay Lea Foods | Skim Milk Powder, | 12.02 |
| Low Temp. | | Low Heat | |
| Water | GFTC* | n/a | 82.98 |
| Mother Culture | | | 5.00 |

*GFTC—Guelph Food Technology Centre
Total (100% w/w)

### Cultured Milk Base Preparation (See Table 16 for Components and Quantities):

1. Weigh out skim milk powder and add water to make fluid milk.
2. Homogenize at 60° C., 2,000 psi single stage.
3. Batch pasteurize at 90° C. for 6 minutes.
4. Cool to 39° C.
5. Add mother culture.
6. Mix thoroughly to disperse culture.
7. Stop agitation and hold blend at 39-40° C. until a pH of 4.5 is obtained.
8. Agitate the cultured base once pH 4.5 is achieved and immediately cool to 5° C.
9. Refrigerate cultured milk base until ready to use in final blend.

TABLE 17
DEV 1764-DX3-5A, Stabilizer Blend

| Ingredient | Supplier | Supplier Code | % w/w |
|---|---|---|---|
| Maltodextrin | Nealanders | Star-Dri 100 | 4 |
| | | (Tate & Lyle) | |
| Sugar | RedPath | Store Purchased | 18.58 |
| Skim Milk Powder, Low | Gay Lea Foods | Skim Milk Powder, | 5.93 |
| Temperature | | Low Heat | |
| Pectin | Dempsey | Pectin Classic | 0.5 |
| | Corporation | CM 203 | |
| Pasteurized Egg Yolk | Burnbrae | 255 | 11.5 |
| | Farms | | |
| Exberry Shade Bordeaux | GNT | Shade Bordeaux | 0.1 |
| Givaudon Flavour | Givaudan | KC-989-481-9 | 0.3 |
| Water | GFTC* | n/a | 59.09 |

*GFTC—Guelph Food Technology Centre
Total (100% w/w)

### Stabilizer Blend Preparation Procedure (See Table 17 for Components and Quantities)

1. Mix eggs with sugar until well blended.
2. Slowly add water to egg-sugar mixture and mix until well blended.
3. Add flavour and colour to water-egg-sugar mixture.
4. Dry blend maltodextrin, pectin, and skim milk powder (ensure pectin is well dispersed to avoid clumping).
5. Add dry blend to water-egg-sugar mixture, and mix until well blended.
6. Homogenize stabilizer blend at 55° C. using a two step homogenization (2,500+500 psi).
7. Pasteurize stabilizer blend at 75° C., hold for 10 minutes.
8. Cool to 4-10° C.

The stabilizer blend began to thicken (as a result of the pectin) if left refrigerated and unprocessed for a period of time. The viscosity of the stabilizer blend may cause processing difficulties during homogenization. Therefore, once the stabilizer blend is formulated, it should be homogenized and pasteurized immediately. The final blend should be assembled immediately after the stabilizer blend is produced.

TABLE 18
DEV 1764-DX3-5A, Final Blend

| Ingredient | Supplier | Supplier Code | % (w/w) |
|---|---|---|---|
| Cultured Base | n/a | n/a | 60.0000 |
| Stabilizer Blend | n/a | n/a | 39.99047 |
| L. helveticus | Lallemand | R0052-150 | 0.00048 |
| L. rhamnosus | Lallemand | R0011-150 | 0.00905 |

### Final Blend Preparation Procedure (See Table 18 for Components and Quantities)

1. Mix stabilizer blend into cultured milk base.
2. Homogenize at 15° C., 1,500+500 psi.
3. Add probiotics and mix until fully dispersed.
4. Bottle and refrigerate.

### Example 7

### Shelf-Life study

The final blend produced from the scale up trial (DEV 1764-DX3-5A) was used to conduct a 6 week shelf life study. The blend was analyzed for microbial growth (total plate (aerobic) count and coliforms) at week 0 (initial), and weeks 1, 2, 3, 4, 5, and 6. The blend was also evaluated for sensory properties (flavour, appearance, texture, and overall acceptability) by three Product Developers at the same time intervals used for microbial analysis above. The results of the microbial analysis and sensory evaluation can be found below in Table 19 and Table 20, respectively.

Enumeration of total aerobic bacteria was performed using 3M™ PETRIFILM™ Aerobic Count Plates, following the Canada Health Protection Branch protocol MFHPB-33 (February 2001). Enumeration of E. coli and Coliforms was performed using 3M™ PETRIFILM™ E. coli Count Plates, following the Canada Health Protection Branch protocol MFHPB-34 (February 2001). Both protocols are available from the Health Canada Food Directorate's Compendium of Analytical Methods, Volume 2. This document is maintained online at http://www.hc-sc.gc.ca/fn-an/res-rech/analy-meth/microbio/index-eng.php.

Results of the microbial analysis are provided in Table 19.

TABLE 19
Microbial Analysis of DEV 1764-DX3-5A
blend over a 6-Week Shelf Life Study

| | Total Plate | | |
|---|---|---|---|
| | (aerobic) Count | | |
| Time | (cfu/mL) | Coliforms (cfu/mL) | E. coli (cfu/mL) |
| Week 0 | <1.00E+00 | <1.00E+00 | <1.00E+00 |
| Feb. 25, 2010 | | | |
| Week 1 | <1.00E+00 | <1.00E+00 | <1.00E+00 |
| Mar. 4, 2010 | | | |
| Week 2 | <1.00E+01 | <1.00E+01 | <1.00E+01 |
| Mar. 11, 2010 | | | |
| Week 3 | <1.00E+01 | <1.00E+01 | <1.00E+01 |
| Mar. 18, 2010 | | | |
| Week 4 | <1.00E+01 | <1.00E+01 | <1.00E+01 |
| Mar. 26, 2010 | | | |
| Week 5 | <1.00E+00 | <1.00E+00 | <1.00E+00 |
| Apr. 1, 2010 | | | |
| Week 6 | <1.00E+01 | <1.00E+01 | <1.00E+01 |
| Apr. 8, 2010 | | | |

The results of the microbial analysis above indicate that the final blend was acceptable throughout the six week shelf life study.

From the sensory comments provided above in Table 20, it was found that the quantity of colouring agent be increased if a more intense colour is desired. It was also found that the quantity of flavouring agent may be increased, to compensate for loss of flavour throughout the shelf life of the product. Although “eggy” flavour notes and sour or acidic flavour notes were detected throughout the shelf life study, no off notes were perceived. In general, the product was considered acceptable throughout the six week shelf life study.

TABLE 20
Sensory Evaluation of DEV 1764-DX3-5A blend over a 6-Week Shelf Life Study

| Time | Sensory Comments |
|---|---|
| Week 0 | Good odour and smooth consistency and texture. Good sweetness level, |
| | egg notes are strong. Good wildberry flavour, however consider increasing |
| | the flavour (loss may be due to processing) and consider increasing colour |
| | if a darker product is desired, no off notes. |
| | Acceptable |
| Week 1 | Good odour and texture. Egg notes are stronger than previous week, and |
| | flavours seem to peak at different times. Flavour has somewhat faded |
| | (perhaps because egg notes are stronger). |
| | Acceptable |
| Week 2 | Good odour and texture. Similar to week 1, however the product has |
| | mellowed and flavours are more well balanced (i.e., product does not have |
| | peaks of different flavours as did the previous week), no off notes. |
| | Acceptable |
| Week 3 | Good odour and texture. Wildberry flavour has decreased and does not |
| | linger as long as in previous weeks, some sour notes are detected, egg |
| | notes continue to be strong, no off notes. |
| | Acceptable |
| Week 4 | Good odour and texture. Similar to week 3 in regards to wildberry flavour. |
| | Some sour notes are detected and egg notes continue to be present, no off |
| | notes. |
| | Acceptable |
| Week 5 | Similar to week 4. Good odour and texture. Eggy notes are strong, |
| | however beverage has mellowed with age (i.e., flavours are well |
| | balanced). Wildberry flavour is not as strong as in previous weeks. |
| | Acceptable |
| Week 6 | Good odour, beverage seems to become better with age (flavours are more |
| | rounded). Beverage seems to have less eggy notes, but more sour type |
| | notes. Wildberry flavour has decreased, no off notes. |
| | Acceptable |

### Example 8

### Probiotic Culture in Stored, Prepared DEV 1764-DX3-5A Blend

An analysis of the probiotic culture in the final blend produced from the scale up trial was conducted by Lallemand. An interim summary of these results can be found in Tables 21 and 22.

Sample preparation: A representative sample of 15 ml of beverage was resuspended in 135 ml of regular buffer (0.1% soy peptone, 0.121% potassium phosphate dibasic and 0.034% potassium phosphate monobasic) and agitated for 30 seconds (10⁻² dilution). The solution was incubated at room temperature with agitation for 6 minutes, and the sample serially diluted with regular buffer to obtain a 10⁻⁵ dilution.

Colony count protocol: A) 0.1 ml of each of the 10⁻², 10⁻³ and 10⁻⁴ dilutions were plated on MRS plates with 5 μg/mlyancomycin (in triplicate). Three to four sterile latex beads were added to each plate and the plates agitated (avoiding swirling movement of the beads) to spread the diluted sample. Plates were inverted for incubation.

B) 0.1 ml of each of the 10⁻², 10⁻³ and 10⁻⁴ dilutions were combined with molten MRS agar containing clindamycin (25 μg/ml) (in triplicate). Agar was poured and allowed to set, and the plates inverted for incubation.

Plates were incubated at 37° C. for 48 hours under anaerobic conditions (GazPak system, BBL) and the colonies counted. Dishes containing between 25 and 250 colonies were considered. Viable cell count (CFU) per gram=(average colony count×dilution factor)/3.

TABLE 21
Probiotic bacteria viability in stored,
prepared DEV 1764-DX3-5A product.

| | Time of | | | Survival |
|---|---|---|---|---|
| Sample description | incubation | | CFU per 250 ml | rate (%) |
| L. helveticus R0052 in | (0 | days) | 1.80E+08 | 100 |
| DX3 recipe A | 11 | days | 7.13E+07 | 39.6 |
| | 4 | weeks | 2.60E+07 | 14.44 |
| | 6 | weeks | 2.18E+07 | 12.11 |
| L. rhamnosus R0011 in | (0 | days) | 3.25E+09 | 100 |
| DX3 recipe A | 11 | days | 1.75E+09 | 53.8 |
| | 4 | weeks | 1.43E+09 | 44.00 |
| | 6 | weeks | 1.38E+09 | 42.46 |

Sample volume column was removed, as the sample volume is provided in the methods.

TABLE 22
Raw data for Probiotic bacteria viability in stored, prepared beverage

| | | | | | | | Dilution | | | | |
|---|---|---|---|---|---|---|---|---|---|---|---|
| | | Time of | CFU | | | | | Inverse | CFU/g | | |
| Sample | Date | incubation | 1 | 2 | 3 | mean | factor | factor | duplicate | mean | CFU/250 ml) |
| L. helveticus | 9/3/2010 | 11 days | 27 | 30 | 25 | 27.33 | −4 | 1000 | 2.73E+05 | 2.85E+05 | 7.13E+07 |
| | | | 26 | 37 | 26 | 29.67 | −4 | 1000 | 2.97E+05 | | |
| | 24/3/2010 | 4 weeks | 101 | 106 | 105 | 104.3 | −3 | 100 | 1.04E+05 | 1.04E+05 | 2.60E+07 |
| | | | 96 | 98 | 117 | 103.67 | −3 | 100 | 1.04E+05 | | |
| | 7/4/2010 | 6 weeks | 76 | 91 | 57 | 74.67 | −3 | 100 | 7.47E+04 | 8.73E+04 | 2.18E+07 |
| | | | 115 | 111 | 107 | 111.00 | −3 | 100 | 9099E+04 | | |
| L. rhamnosus | 9/3/2010 | 11 days | 61 | 64 | 60 | 61.67 | −5 | 10000 | 6.17E+06 | 6.98E+06 | 1.75E+09 |
| | | | 83 | 71 | 80 | 78.00 | −5 | 10000 | 7.80E+06 | | |
| | 24/3/2010 | 4 weeks | 76 | 66 | 60 | 67.33 | −5 | 10000 | 6.73E+06 | 5.73E+06 | 1.43E+09 |
| | | | 56 | 31 | 55 | 47.33 | −5 | 10000 | 4.73E+06 | | |
| | 7/4/2010 | 6 weeks | 61 | 55 | 58 | 58.00 | −5 | 10000 | 5.8E+06 | 5.50E+06 | 1.38E+09 |
| | | | 53 | 47 | 56 | 52.00 | −5 | 10000 | 5.2E+06 | | |

All citations are herein incorporated by reference, as if each individual publication was specifically and individually indicated to be incorporated by reference herein and as though it were fully set forth herein. Citation of references herein is not to be construed nor considered as an admission that such references are prior art to the present invention.

One or more currently preferred embodiments of the invention have been described by way of example. The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

1-20. (canceled)

21. A beverage comprising:
a fermented milk product; and
a fermented enhanced egg yolk product.

22. The beverage of claim 21, wherein the fermented milk product is yogurt.

23. The beverage of claim 21, further comprising one or more of omega-3 fatty acids, phosphatidyl choline, vitamin D, or a combination thereof.

24. The beverage of claim 23, wherein the vitamin D is vitamin D2.

25. The beverage of claim 23, wherein the omega-3 fatty acids are docosahexaenoic acid (DHA), eicosapentaenoic acid (EPA), alpha-linolenic acid (ALA), or a combination thereof.

26. The beverage of claim 21, further comprising one or more probiotic microbial strains.

27. The beverage of claim 26, wherein the one or more probiotic microbial strains are selected from the group consisting of: Lactobacillus helveticus, Lactobacillus acidophilus spp, Lactobacillus casei sp, Lactobacillus rhamnosus GG, Lactobacillus reuteri, Lactobacillus delbrueckii bulgaricus, Lactobacillus planatarum spp., Lactobacillus fermentum KLD, Lactobacillus johnsonii, Bifidobacterium bifidum, Bifidobacterium breve, Bifidobacterium infantis, Bifidobacterium longum, Enterococcus faecium, Escherichia coli Nissle 1917, Streptococcus salivarus subsp Thermophilus, and Saccharomyces boulardii.

28. The beverage of claim 27, wherein the one or more probiotic microbial strains are selected from the group consisting of: Lactobacillus helveticus, Lactobacillus acidophilus, Lactobacillus rhamnosus GG, Streptococcus thermophilus and Lactobacillus bulgaricus.

29. The beverage of claim 22, wherein the pH of the yogurt is in the range of about 4.3 to about 4.6.

30. The beverage of claim 21, wherein the fermented milk product comprises 20 to 80% (w/w) of the total beverage.

31. A method of making a beverage comprising a fermented milk product and a fermented enhanced egg yolk product, the method comprising combining a culture base with a stabilizer blend, wherein the culture base comprises from 40 to 80% w/w of the beverage.

32. The method of claim 31, wherein the culture base is prepared by:
homogenizing fluid milk;
adding a yogurt mother culture; and
incubating at a suitable temperature until a pH of between about 4.2 to about 4.6 is reached.

33. The method of claim 32, wherein the fluid milk is reconstituted dried skim milk.

34. The method of claim 32, wherein the yogurt mother culture comprises Streptococcus thermophilus, Lactobacillus bulgaricus or a combination thereof.

35. The method of claim 31, wherein the stabilizer blend comprises one or more of maltodextrin, a sweetener, milk powder, a thickener, an egg product, a flavour or a colour.

36. The method of claim 31, wherein the egg product comprises omega-3 fatty acids, vitamin D, phosphatidylcholine or a combination thereof.

37. The method of claims 31, further comprising a step of adding one or more probiotic microbial strains.

38. The method of claim 37 wherein the one or more probiotic microbial strains are selected from the group consisting of: Lactobacillus helveticus, Lactobacillus acidophilus spp, Lactobacillus casei sp, Lactobacillus rhamnosus GG, Lactobacillus reuteri, Lactobacillus delbrueckii bulgaricus, Lactobacillus planatarum spp., Lactobacillus fermenturn KLD, Lactobacillus johnsonii, Bifidobacterium bifidum, Bifidobacterium breve, Bifidobacterium infantis, Bifidobacterium longum, Enterococcus faecium, Escherichia coli Nissle 1917, Streptococcus salivarus subsp Thermophilus, and Saccharomyces boulardii .

39. The method of claim 38, wherein the one or more probiotic microbial strains are selected from the group consisting of: Lactobacillus helveticus, Lactobacillus acidophilus, Lactobacillus rhamnosus GG, Streptococcus thermophilus and Lactobacillus bulgaricus.

40. A method of providing nutrition to a subject, the method comprising administering to the subject a beverage according to claim 21.
